(19) United States
(12) Patent Application Publication
(10) Pub. No.: US 2016/0103200 A1
(43) Pub. Date: Apr. 14, 2016

(54) SYSTEM AND METHOD FOR AUTOMATIC TRACKING AND IMAGE CAPTURE OF A SUBJECT FOR AUDIOVISUAL APPLICATIONS

(71) Applicant: TELEMETRICS INC., Mahwah, NJ (US)

(72) Inventor: Eduardo LoPresti, Sparkill, NY (US)

(21) Appl. No.: 14/514,161

(22) Filed: Oct. 14, 2014

(51) Int. Cl. G01S 3/786; H04N 5/232

(52) U.S. Cl. CPC G01S 3/7864; H04N 5/23203

(57) ABSTRACT

A system and method for automatically tracking and capturing an image of a subject is disclosed. The system and method includes at least one magnetic emitter device emitting a magnetic field, a magnetic sensing device enabled to receive the magnetic field from the magnetic emitter device and the magnetic sensing device is attached to at least one subject. The system and method further includes an image capturing device in communication with the to the magnetic sensing device in which the magnetic sensing device is enabled to communicate data to the image capturing device and the data enables the image capturing device to track a position of the subject. The image capturing device captures an image of the subject.

### FIELD OF THE INVENTION

The invention relates to audiovisual systems, and more specifically to systems and methods to automatically track a position of a subject within the range of a magnetic field around the subject to facilitate capturing an image of the subject by an image capture device.

### BACKGROUND OF THE INVENTION

Through the evolution of robotics and automatic presenter tracking systems, visual presentations using automated systems have become commonplace. This capability has significantly increased remote attendance through the web, as well as event storage for a variety of situations, such as remote classrooms, professional conferences, legal and political debates, large area security and much more.

The traditional technologies used in automatic presenter tracking systems struggle to keep pace with the increasing range of audiovisual needs. This has become challenging when dealing with advanced technology audiovisual conference rooms, meeting rooms, churches, classrooms, auditoriums, virtual sets, etc. Automatic presenter tracking systems technologies can be categorized as follows:

Horizontal (no vertical) Motion Detection Follower

Horizontal (limited vertical) Infrared (with pendant) Follower

Horizontal (limited vertical) Face Recognition

Horizontal (no vertical) Sound Follower

Vertical plus Horizontal Telemetry Data Follower

Some manufacturers have used a combination of these techniques, such as sound combined with face recognition. Even in those cases, horizontal (pan) and vertical (tilt) is limited to a narrow visual range and rarely including the audience.

FIG. 1 illustrates an exemplary conventional systems used in tracking and monitoring a subject such as a presenter in a lecture environment. Conventional applications are generally limited to one presenter on stage moving linearly (left-right only) in front of the audience, with a fixed camera zoom camera shot. Other limitations of conventional automatic presenter tracking systems include:

Only one presenter to move horizontally left-right on depth limited stage.

Only one camera and one presenter.

Limited room size, layout and lighting for tracking.

Sometimes effective indoors, inoperative or difficult outdoors.

Camera location must be centered in front of the presenter stage.

Presenter cannot move freely behind or around the tracking camera.

Automatic re-acquisition of a lost signal is difficult if not impossible.

Often requires presenters wear visible devices which can be distracting.

Two cameras are required one for sensing one for video.

Examples of conventional systems include the following.

The Motion Detection Camera Tracking Method. This system uses security camera motion detection technology, often combined with pre-programmed preset camera controls activated by electromechanical triggers such as step mat or by manually activated switches aided by IR detectors. It uses two cameras mounted close together; one for motion detection and one for video to ensure both cameras have the same field of view. The motion detection camera is adjusted to a wide-angle shot to see the whole presentation area and the video tracking camera looks at a smaller area and pans back and forth to follow a presenter. Only one person is allowed on stage. If more than one person is on stage, or something is moving in the visual range of the motion detection, tracking may stop and in many cases begin to track the wrong individual or freeze up locked on a bright object. Changes in lighting in the room from a projector or sunlight from a window can be interpreted as motion changes and cause tracking disruptions.

The limitation of this type of tracking system is that it is a technology that relies on motion and changes in brightness to follow the presenter in a limited area. Changes in lighting or distance from the sensing camera will influence the image and the system's ability to track the presenter. This method can be difficult to install and calibrate, requiring factory trained experts to operate. The motion tracking can be unreliable unless aided by triggers (mats, buttons, etc.) and requires a tandem of two cameras, one for motion and one for video and both cameras must be centered in front of the stage. In addition, a fixed zoom position and horizontal (pan) only are available in these systems and pan is limited to the wide angle capability of the motion sensing camera. Finally, motion tracking can be manually disabled providing for only preset shots if the auto tracking system stops working or image becomes too jerky.

The IR Pendant Detection Camera Tracking Method. Pendant camera tracking requires an infrared (IR) illuminator worn as a necklace, or a clip on device by the presenter that can be seen by a specialized IR camera. The IR camera follows the presenter IR source in the scene, commanding the video camera to follow the IR source in real time.

Experience in this environment has identified a few limitations of IR tracking. First, the necklace can be covered by clothing or become invisible all together when presenters turn their back to the IR camera. Despite thoughtful design and engineering, some presenters find the necklace cumbersome and prefer not to wear it over time, instead relying only on presets and static camera angles. In addition, the distance to the IR camera is limited to about 30 feet due to IR camera sensitivity or IR interference. Other IR sources, such as sunlight or florescent lights, make the target harder to find by the IR camera. Even bright lights with little IR content can lock-up an IR specialized camera. The IR camera has also trouble detecting depth of field, which means autofocus loss of the IR camera and the tracking video shot can become jerky or suddenly lockup.

The IR autotracking is limited by the vertical displacement of the IR source on the IR sensing camera image that occurs when the presenter moves back-forth instead of left-right because the camera(s) are aimed down from a high location down to the stage. Finally, illuminator failures and dead batteries tend to be an issue in systems that are frequently used. Though some systems have equipment cases that both secure and recharge the lanyards, the maintenance of the system reduces the overall practicality of use.

The Face Recognition Camera Tracking Method. Computer processing is becoming more powerful and cheaper to integrate into new devices and has led to the development of computer-based tracking. It is effective in a short distance and well-lit video conferencing arena and performs to expectations within a controlled conference style room. Using custom software, a computer-based processor analyses the video image in real time and identifies the subject's eyes within a frame. Much like your digital camera will identify red eye, the processor uses the subject's eyes in the image to get an idea where the presenter is in the frame. Once the camera knows where the subject is, the camera will look for the motion of the subject's lips to confirm who in the frame is talking. Some makers use the aid of sound detection with two microphones to find the presenter.

The face recognition systems can result in disadvantages due to variable lighting and distance from the camera that will influence the clarity of the captured image, affecting the system's ability to recognize and track the subject. These systems are limited to small spaces and to one robotic camera and require initialization before the tracking can begin. The system cannot be used in virtual studios or sets. In addition, movements like turning his or her head a little too far off axis can make for unpredictable results in how the processor interprets the image.

The Audio Based Tracking by Sound Source Localization (SSL). The key advantages of the SSL tracking method is the technology approach which separates the camera, control, and processor from each other. In this method the depth of the room, lighting, room finishes, or pendants are irrelevant to the performance of the system. The combination of sound systems, pressure mats, and IR sensors can create a technology for a multipurpose room. However, this proves a complex design challenge, requiring an integrated design and engineering approach.

The disadvantages of this approach can occur when the voices from two people get into a discussion and may be problematic for the system to decide who to follow. A microphone amplifier sound device may cause tracking to be lost. SSL systems are only effective in small rooms for videoconferencing and only a single presenter is allowed to be talking at a time. In addition, only one fixed zoom position horizontal panning camera system can be sued and the system is not scalable resulting in being limited to small spaces and one robotic camera. Finally, SSL requires initialization resulting in difficult acquisition of the presenter at start up. The system cannot be used in virtual studios or sets.

Thus, the present systems and methods disclosed herein have been developed to overcome the disadvantages described above. The present systems and methods describe various embodiments for scalable audiovisual systems that work in large multifunctional nontraditional spaces.

### SUMMARY OF THE INVENTION

A system for automatically tracking and capturing an image of a subject is disclosed. The system includes at least one magnetic emitter device, at least one magnetic sensing device attached to at least one subject enabled to receive a magnetic field from the magnetic emitter device. The system further includes an image capturing device in communication with the to the magnetic sensing device in which the magnetic sensing device is enabled to communicate position data to the image capturing device and the position data enables the image capturing device to track a position of the subject.

Also disclosed is a method for automatically acquiring a position of a subject. The method includes receiving at at least one magnetic sensing device attached to at least one subject a magnetic field from at least one magnetic emitter device and processing the magnetic field to determine a position of the at least one magnetic sensing device. The method includes communicating the position data of the subject based on the position of the magnetic sensing device to an image capturing device.

In addition, a method for automatically directing an image capturing device to a subject position is disclosed. The method includes receiving at the image capturing device a position data from a magnetic sensing device attached to a subject and processing the position data to determine a position for directing the image capturing device. The method also directs the image capturing device to the position of the magnetic sensing device to capture an image of the subject based on the position of the magnetic sensing device.

The systems and methods discussed below are advantageous over the prior art because the presenter is totally free to move, stand, sit, and turn in any direction within the magnetic field cover zone, without risk of losing tracking. The Image capturing devices can be placed anywhere in the area and may be chosen based performance. A multiple number of Image capturing devices can be controlled, even if there is only one presenter allowing many different shots to be obtained. Several presenters can be tracked simultaneously and choreographed utilizing full automatic Pan, Tilt, Zoom and Focus control of all cameras in 360 degree horizontal pan camera control (presenter can even walk around the camera). Vertical Tilt camera control (within PTZ or pan/tilt limits) may be included and the system is fully scalable from one presenter one camera in a small room to multiple cameras. The Presenter hub does not have to be visible and can be covered by clothing or worn anywhere on the body. The systems and methods presented allow automatic re-acquisition is reliable once presenter is in the coverage area.

### BRIEF DESCRIPTION OF THE DRAWINGS

FIG. 1 is a diagram illustrating elements of a prior art location tracking and monitoring system in an exemplary presentation environment;

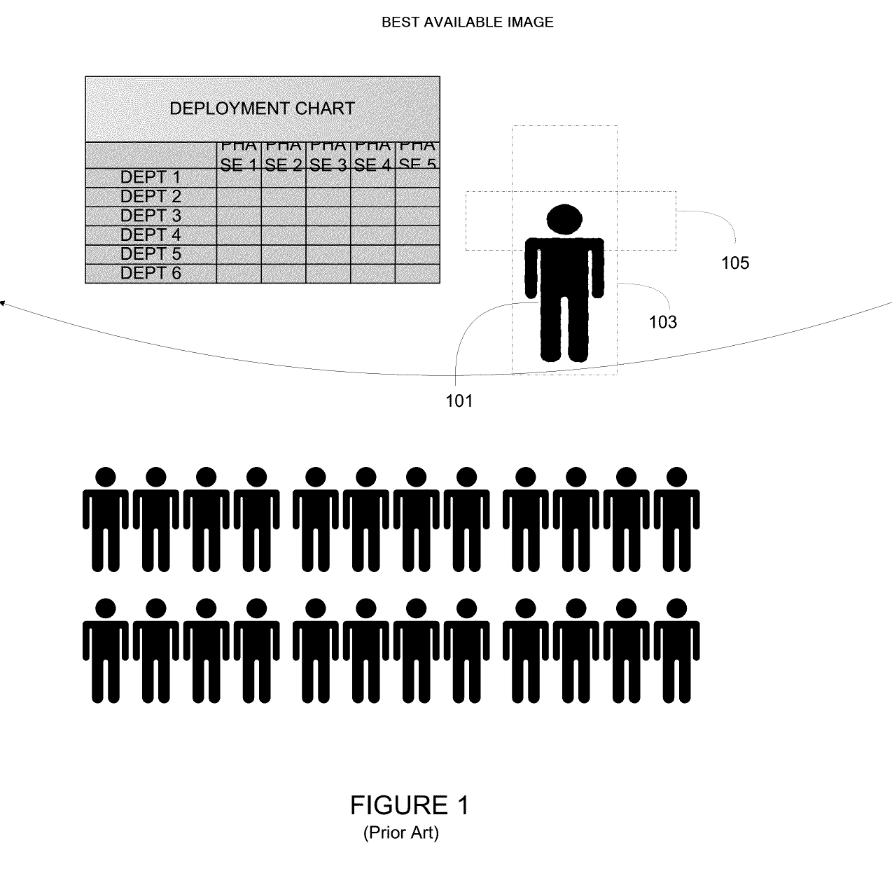

FIG. 2 is an exemplary block diagram of a basic configuration illustrating exemplary elements of the automatic position tracking and image capturing system of the present invention;

FIG. 3 is an exemplary block diagram of degrees of freedom of a magnetic field that may be emitted by a magnetic emitter device in an exemplary embodiment of the present invention;

FIG. 4 is an exemplary block diagram of various elements which may be part of the magnetic emitter device in an exemplary embodiment of the present invention;

FIG. 5 is an exemplary block diagram of various elements of a processor which may be part of a magnetic sensing device of the present invention;

FIG. 6 is an exemplary block diagram of components which may be part of a position processing unit in the magnetic sensing device of the present invention;

FIG. 7 is an exemplary block diagram of various elements which may be part of an exemplary image capturing device of the present invention;

FIG. 8 is an exemplary block diagram of components which may be part of a control unit of the image capturing device of the present invention;

FIG. 9 is an illustration of an exemplary magnetic sensing device attached to a subject in an exemplary embodiment of the present invention;

FIG. 10 is an exemplary block diagram of a subject within a range of a magnetic field generated by the magnetic emitter of the present invention;

FIG. 11 is an exemplary block diagram illustrating elements of an automatic position tracking and image capturing system in an exemplary presentation environment of the present invention;

FIG. 12 is a flow diagram of a method for acquiring a subject position by the magnetic sensing device in an exemplary embodiment of the present invention;

FIG. 13 is a flow diagram of a method for directing the image capturing device to a subject position in an exemplary embodiment of the present invention; and

FIG. 14 is an illustration of an exemplary application of an embodiment of the elements of the automatic position tracking and image capturing system of the present invention.

### DETAILED DESCRIPTION OF THE INVENTION

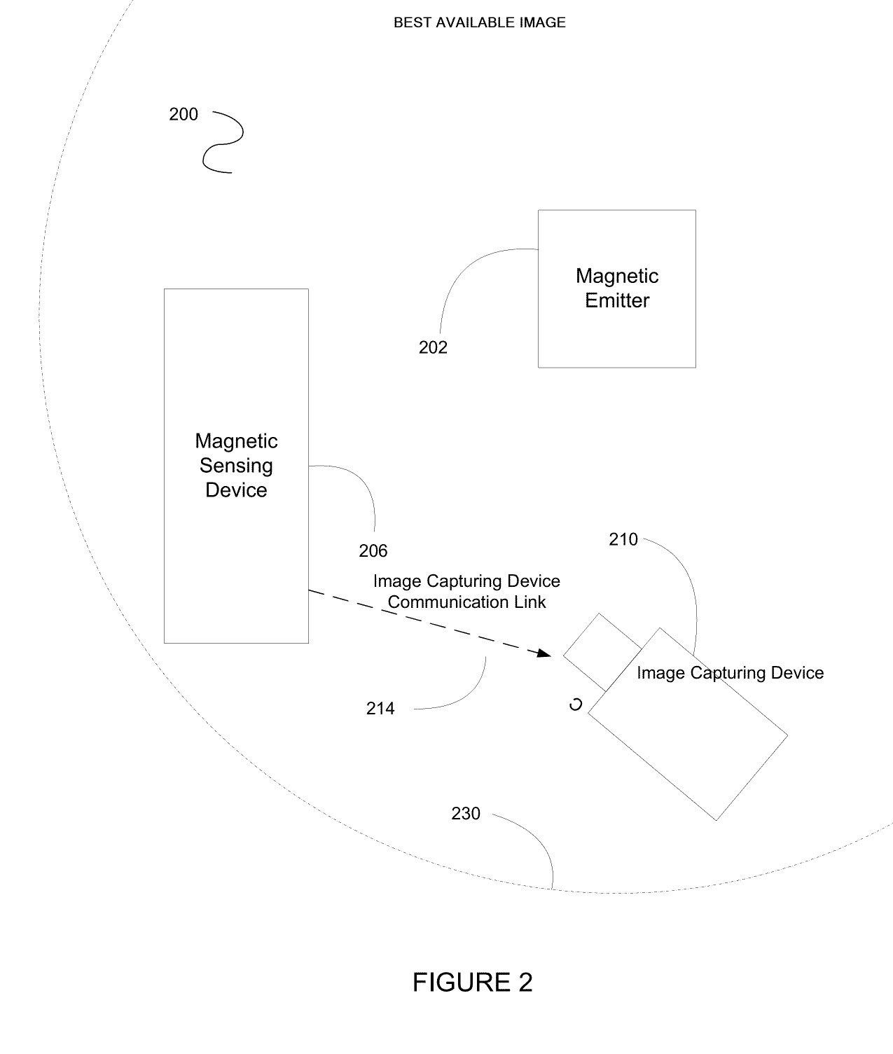

Systems and methods for establishing an automatic position tracking and image capturing system are described in connection with FIGS. 2-12. These systems and methods make it possible to enable an image capturing device such as a robotic camera, for example, to automatically track a subject for capturing an image of the subject in traditional and nontraditional environments without the disadvantages of conventional systems.

Although the following descriptions use a limited number of image capturing devices, magnetic emitter devices and magnetic sensing devices, it is understood that any number of elements described below can be used in the automatic position tracking and image capturing system presented herein.

Referring to FIG. 2, an example of a basic configuration of the present invention is presented illustrating the exemplary elements of an automatic position tracking and image capturing system 200. The system includes at least one magnetic emitter 202 which may emit an AC magnetic field 230. The AC magnetic field 230 may be received by a moving magnetic sensing device 206. The magnetic sensing device 206 processes the emission signal of magnetic field 230, as will be discussed further below, to determine a position of magnetic sensing device 206. Magnetic sensing device 206 may then transmit the position data to image capturing device 210. The position data from magnetic sensing device 206 may then be processed by image capturing device 210 providing directional guidance to image capturing device 210. As magnetic sensing device 206 moves, image capturing device 210 continues to receive the changing position data from magnetic sensing device 206 and, thus, may track magnetic sensing device 206 applying the systems and methods described herein.

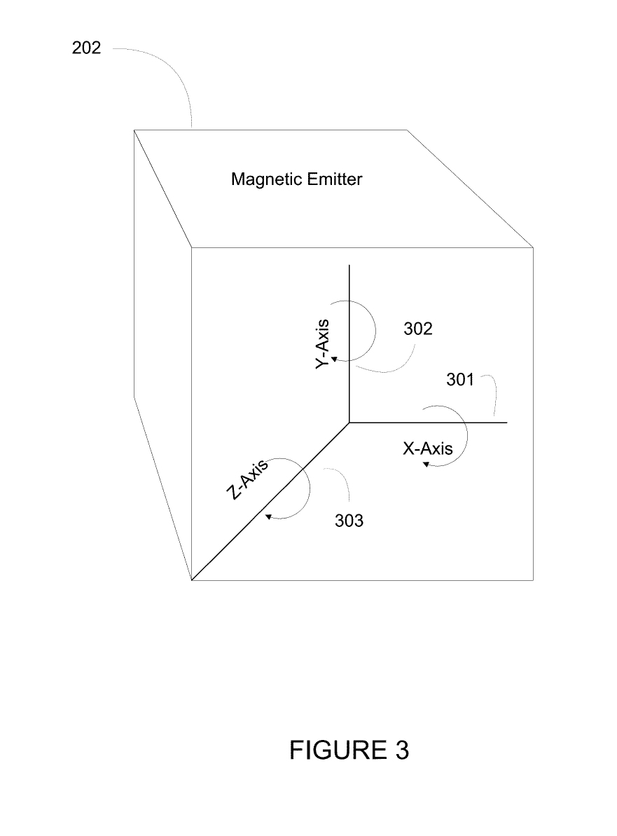

FIG. 3 is an exemplary block diagram of the degrees of freedom of a magnetic field 230 that can be emitted by magnetic emitter 202. The magnetic emitter 202 emits a magnetic field 230 rotationally along each axis x 301, y 302 and z 303, which may be received by magnetic sensing device 206.

Although magnetic emitter 202 is shown in FIG. 3 in a cubic geometric form, it is understood that magnetic emitter 202 may take almost any geometric form that provides the necessary space for the elements of magnetic emitter 202 in examples described below.

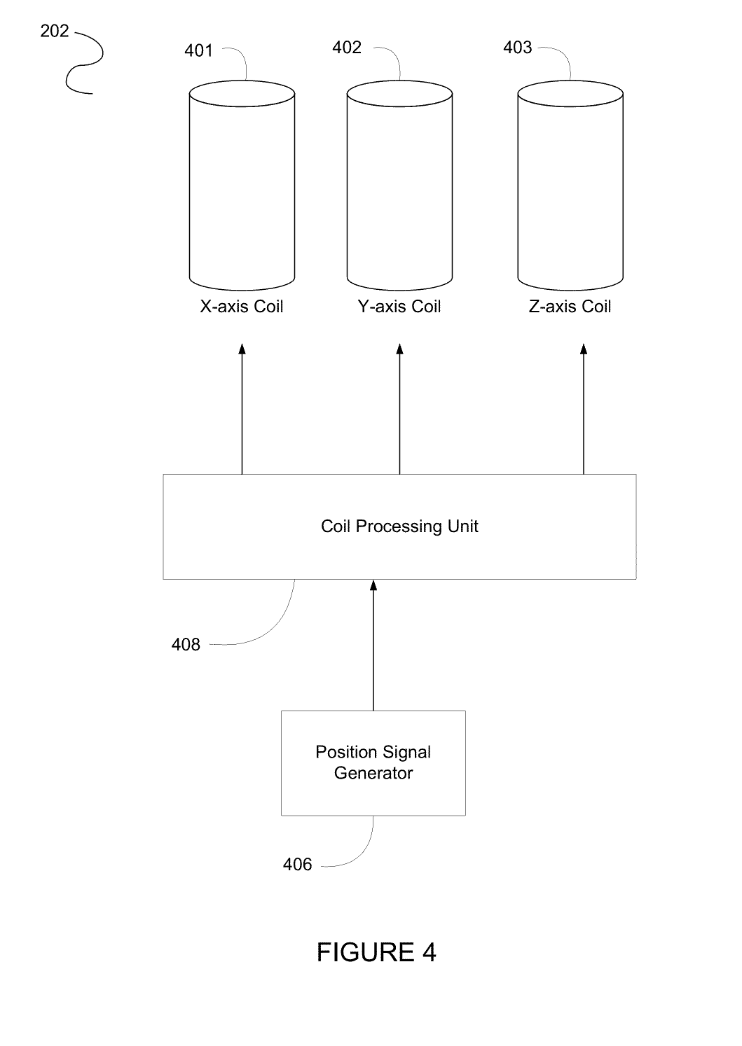

FIG. 4 is an exemplary block diagram of various elements which may be part of magnetic emitter 202. Magnetic emitter 202 may include, for example, a position signal generator 406 that sends an electronic signal to a three channel coil processing unit 408. The three channel coil processing unit 408 is electronically connected to three transducer coils configured to emit a magnetic signal from the magnetic emitter 202 for each of the axis x 301, y 302 and z 303. The three channel coil processing unit 408 sends the electronic signal at different frequencies to each of the coils 401, 402 and 403 thus allowing the axis to be distinguished when received by magnetic sensing device 206.

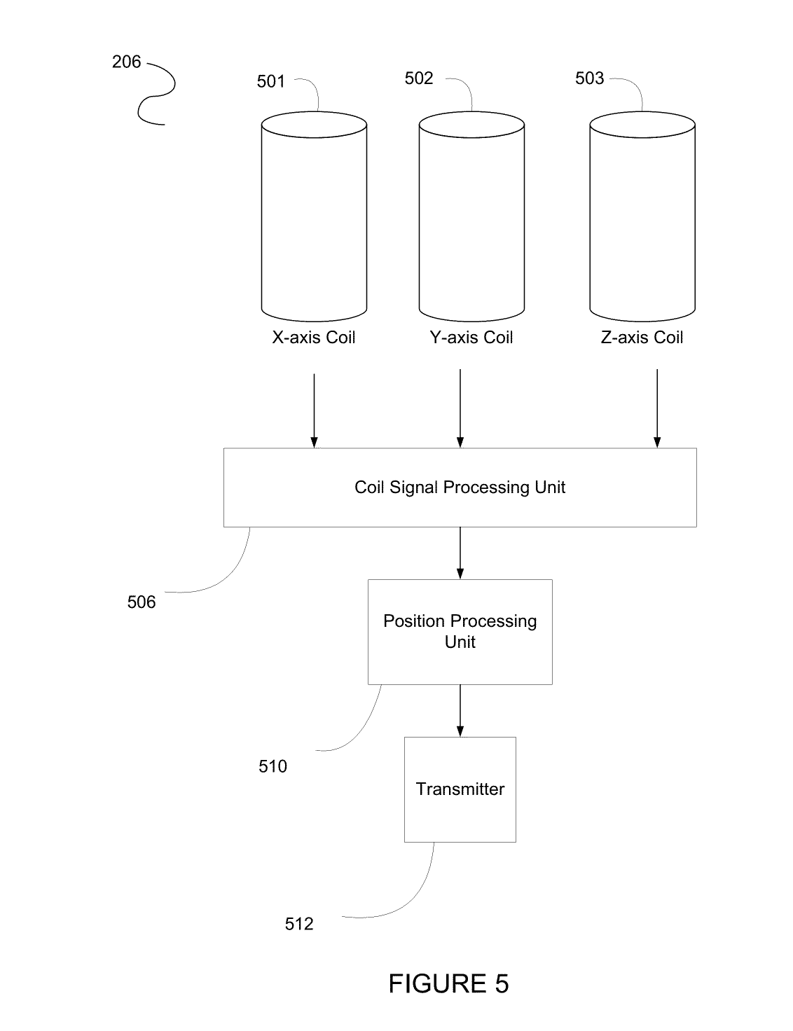

FIG. 5 is a block diagram of various exemplary elements which may be part of the magnetic sensing device 206. Magnetic sensing device 206 may include three transducer receiving coils for each of orthogonal axis x 501, y 502 and z 503. The transducer coils 501, 502, 503 may be connected to a coil signal processing unit 506 that produces an electronic signal related to a voltage output which is dependent on the magnetic field 230 received on the coils. The electronic signal from coil signal processing unit 506 is then communicated to position processing unit 510 to estimate the absolute position and orientation of the moving magnetic sensing device 206 relative to the magnetic emitter 202. The position data from position processing unit 510 is communicated to transmitter 512 for transmission to the image capturing device 210.

The transmitter 512 may be included as a component of magnetic sensing device 206 or separate from magnetic sensing device 206 but connected to magnetic sensing device 206 by a physical cable or wireless connection. The wireless connection may include any appropriate wireless standard, including, but not limited to Bluetooth©, IEEE 802.11 series standards, RF signal or other appropriate means.

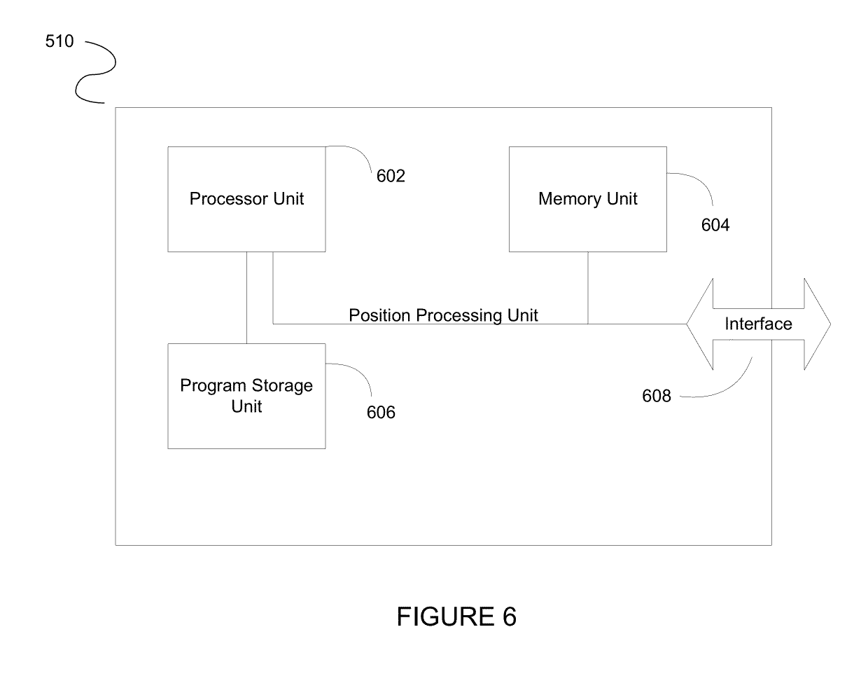

FIG. 6 is an exemplary block diagram of components which may be part of a position processing unit 510 in magnetic sensing device 206 in an exemplary embodiment of the present invention. Position processing unit 510 may include a processor unit 602 in communication with a program storage unit 606. Program storage unit 606 may provide various programming software that may be implemented by processor unit 602, including programming for determining position data derived from received magnetic field 230 at transducer receiving coils 501, 502, 503. Position processing unit 510 may also include memory for storing position data, for example, and may include an interface 610 for receiving signals from coil signal processing unit 506 and for communicating position data to transmitter 512.

It should be understood that the above descriptions are meant as examples only placed in simplest terms to aid in understanding the systems and methods described herein, and are not intended to be limiting embodiments of the present invention. For example, magnetic emitter 202 and magnetic sensing device 206 may include additional coils and a plurality of elements described above as well as additional elements not shown. Position processing unit 510 may include more than one processor unit 602 and additional memory units 604 and programing storage units 606, as well as other components not shown.

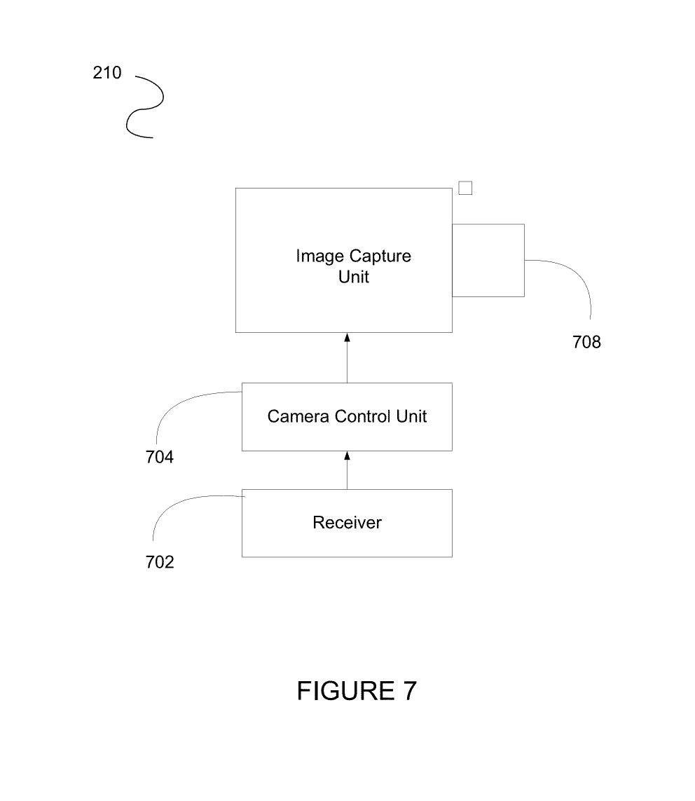

FIG. 7 is an exemplary block diagram of various elements which may be part of an exemplary image capturing device 210. The image capturing device 210 may include a receiver 702 for receiving position data from magnetic sensing device 206. The image capturing device 210 may include a control unit 704 which may receive position data from magnetic sensing device 206 received through receiver 702. Image capture device 210 may also include an image capture unit 708 which is enabled to mechanically move according to received commands. Control unit 704 may send commands to image capture unit 708 which enables the image capture unit 708 to move according to commands from control unit 704.

The control unit 704 and receiver 702 may be an integral part of image capturing device 210 or may be separate elements in communication with image capturing device 210 through a cable or wireless connection. The wireless connection may include any appropriate wireless standard, including, but not limited to Bluetooth©, IEEE 802.11 series standards, RF signal or other appropriate means.

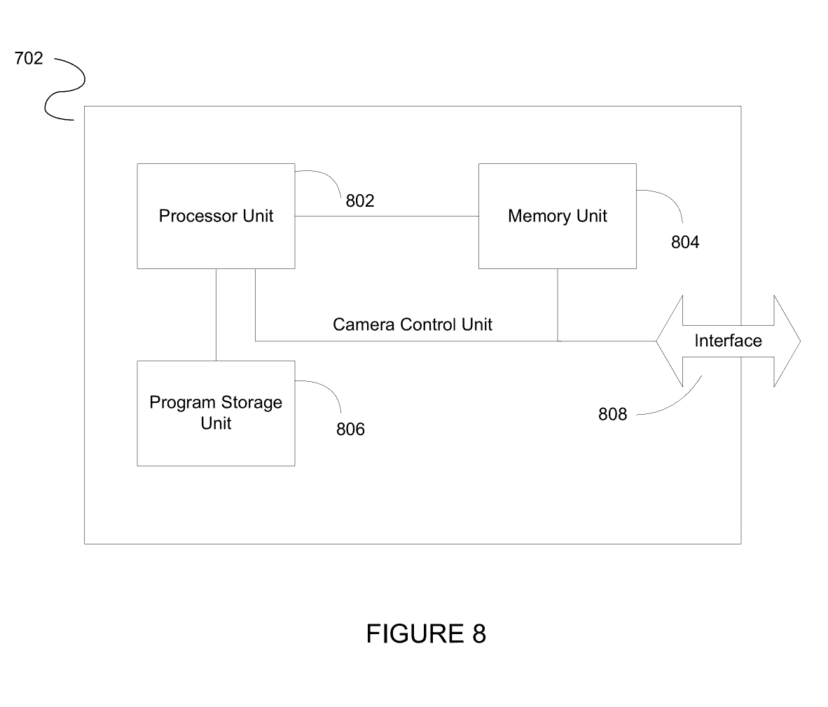

FIG. 8 is an exemplary block diagram of components which may be part of a control unit 704 of the automatic position tracking and image capturing system of the present invention. Control unit 704 may include processor unit 802 in communication with a program storage unit 806. Program storage unit 806 may provide various programming software that may be implemented by processor unit 802, including programming for determining directional information derived from position data received from magnetic sensing device 206. Directional processing unit 702 may also include a memory unit 804 for storing data, such as position data for directional information, for example, and may include an interface 810 for communicating directional information to image capture unit 708.

Control unit 704, although discussed above as including one processor 802, may include many processors and other components including components not shown, and may include controls for other aspects of image capturing device 210 such as pan, tilt, zoom, focus and other control features.

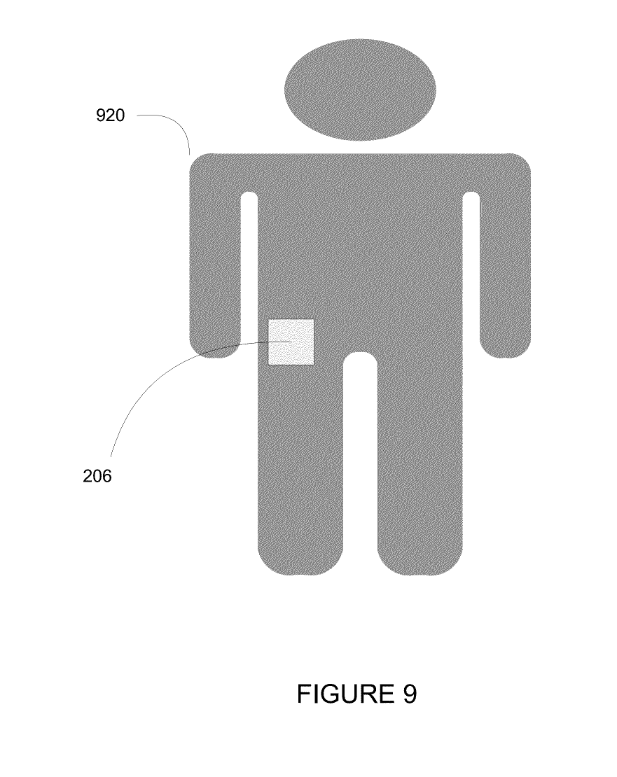

FIG. 9 is an illustration of an exemplary magnetic sensing device attached to a subject 920 in an exemplary embodiment of the present invention. The subject 920 may be a presenter in a meeting or lecture room, for example, and wears magnetic sensing device 206 in an unobtrusive manner, such as in a pocket or under clothing in some manner, allowing the image capturing device 210 (not shown) to track subject 920 through magnetic sensing device 206.

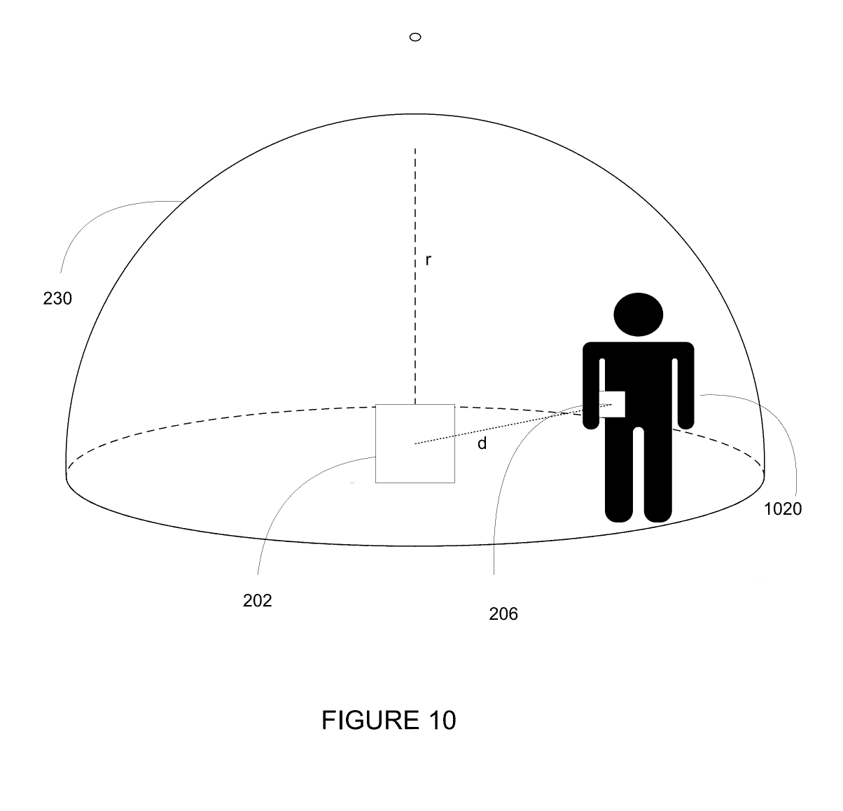

Turning now to FIG. 10, an exemplary block diagram of a subject 1020 within a range of magnetic field 230 generated by an exemplary magnetic emitter 202 is shown. The magnetic emitter 202 emits magnetic field 230 of radius r. The attenuation of magnetic field 230 is proportionate to 1/d³, where d is the distance between the transducer coils 401, 402, 403 of magnetic emitter 202 and the receiving transducer coils 501, 502, 503 of magnetic sensing device 206. Thus, radius r represents a maximum distance that magnetic field 230 has sufficient signal resolution to enable magnetic sensing device 206 to detect the magnetic field 230. A subject 1020 is shown within the range of radius r of magnetic emitter 202. The subject 1020 includes a magnetic sensing device 206 in his possession, for example, hidden in the pocket of subject 1020. In the exemplary embodiment of FIG. 10, as magnetic sensing device 206 remains within the range of magnetic emitter 202, the magnetic sensing device 206 is enabled to determine a position of magnetic sensing device 206 and consequently of subject 1020 in possession of magnetic sensing device 206. Magnetic sensing device 206 may then transmit the position data to image capturing device 210 (not shown) in accordance with methods described below.

In the event subject 1020 exits the magnetic field 230, the magnetic sensing device 206 will no longer be enabled to determine a position with respect to magnetic emitter 202. As a result image capturing device 210 will no longer track subject 1020. However, immediately upon reentry into magnetic field 230, the magnetic sensing devices 206, re-acquires the signal from magnetic emitter 202 because magnetic sensing devices 206 is continually sensing magnetic field 230. Thus, the magnetic sensing device 206 may continue to communicate position data to image capturing device 210 so that the subject 1020 may continue to be tracked by image capturing device 210 within their respective magnetic field 230.

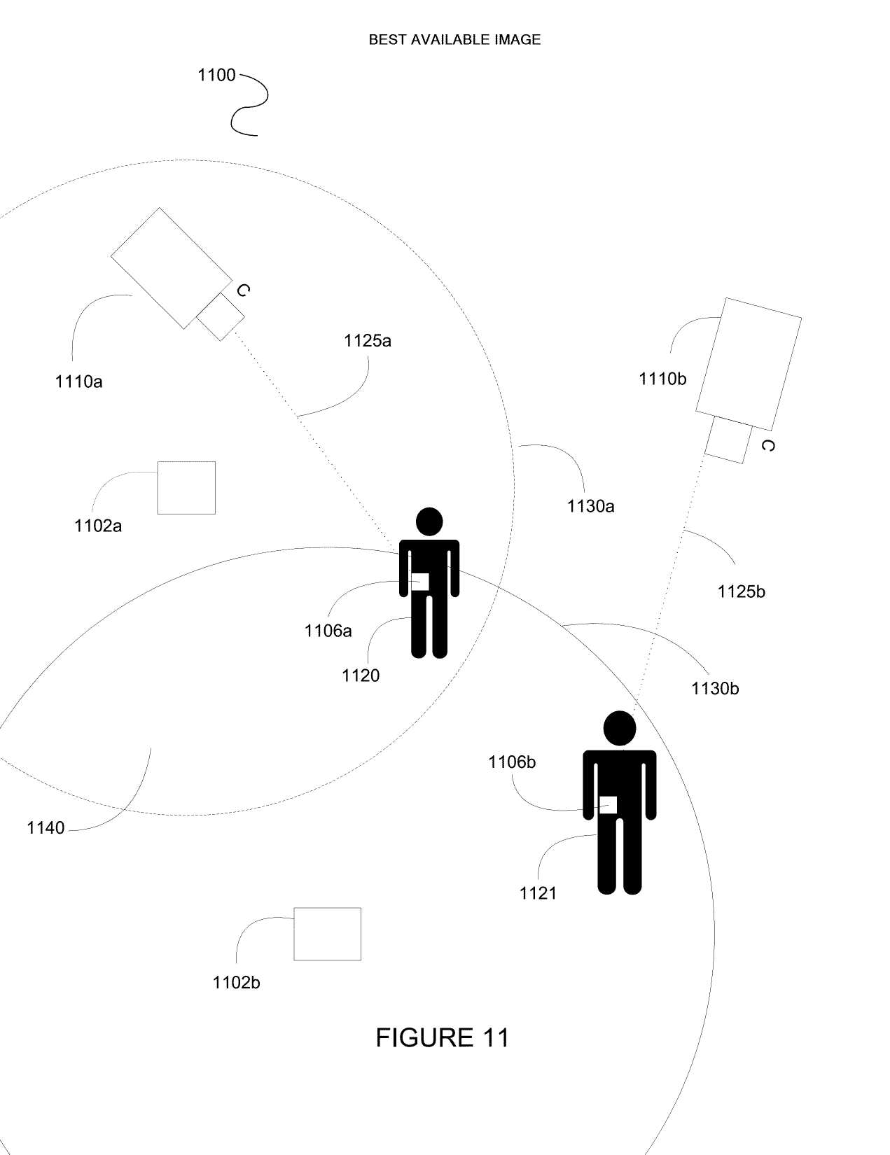

FIG. 11 is an exemplary block diagram illustrating elements of an automatic position tracking and image capturing system in an exemplary presentation environment 1100 of the present invention. The presentation environment 1100 includes two presenters 1120 and 1121. Each presenter 1120 and 1121 possesses magnetic sensing devices 1106a and 1106b respectively which receive the emission signals from magnetic fields 1130a and 1130b emitted from magnetic emitters 1102a and 1102b respectively. In this example, presenter 1120 possessing magnetic sensing device 1106a in which magnetic sensing device 1106a receives emission signals (301a, 302a, 303a not shown) of magnetic field 1130a emitted from magnetic emitter 1102a within magnetic field 1130a. Similarly, presenter 1121 possesses magnetic sensing device 1106b in which magnetic sensing device 1106b receives emission signals (301 b, 302b, 303b not shown) of magnetic field 1130b emitted from magnetic emitter 1102b. Image capturing device 1110a receives position data from magnetic sensing device 1102a through, for example, RF signal 1125a. Image capturing device 1110b receives position information from magnetic sensing device 1102b through, for example, RF signal 1125b. In this manner, there is no confusion among the image capturing devices 1110a, 1110b as to which presenter 1120, 1121 to track. Each of the presenters 1120, 1121 is free to move about a stage area within the respective magnetic fields 1130a, 1130b and will be uninterruptedly tracked by image capturing devices 1110a and 1110b respectively by continually receiving updated position data from magnetic sensing devices 1106a and 1106b respectively. In addition, each presenter 1120, 1121 may freely move into crossover area 1140 between magnetic field 1130a and 1130b without loss of signal or ability to be tracked by the respective image capturing devices 1110a, 1110b.

Although as described above, image capturing devices 1110a and 1110b receive position data through RF signals 1125a and 1125b respectively, image capturing devices 1110a and 1110b may also receive position data from magnetic sensing devices 1106a and 1106b through, for example, a wireless signal such as Bluetooth©, IEEE 802.11 series standards or other appropriate means. Although the above discussed embodiments of the automatic position tracking and image capturing system included two of each of magnetic emitters 1102a, 1102b; magnetic sensing devices 1106a, 1106b; image capturing devices 1110a, 1110b; and subjects 1120, 1121, many combinations are possible and the above discussed examples are not intended to limit the possible embodiments and system configurations. For example, the above discussed systems may be configured for one magnetic emitter, one magnetic sensing device, one subject and several image capturing devices providing a variety of perspective video transmissions of the subject.

In an alternate embodiment, several of each of magnetic emitters, magnetic sensing devices and image capturing devices may track several subjects in order to automatically follow each presenter with one or several image capturing devices and provide a presentation of the captured image of each of the several subjects.

In another embodiment, the system may include several subjects and each subject may possess magnetic sensing devices that are in communication individually with image capturing devices, thus tracking each subject individually.

The automatic position tracking and image capturing system of the present invention provides multiple combinations of magnetic emitters, magnetic sensing devices and image capturing devices that can be used to follow a subject in a desired presentation environment.

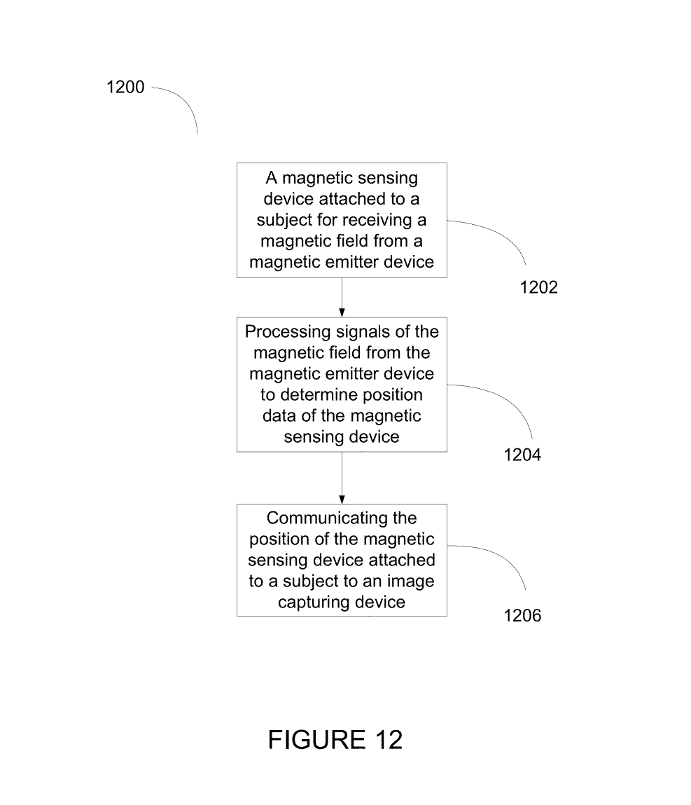

FIG. 12 is a flow diagram of steps of a method 1200 for acquiring a subject 1020 position in an exemplary embodiment of the present invention. Referring also to FIGS. 2-6 and 10, the method 1200 begins at step 1202 where a magnetic sensing device 206 attached to subject 1020 receives the detected magnetic field 230 emitted from a magnetic emitter 202. Magnetic emitter 202 generates magnetic field 230 at different frequencies signals 301, 302, 302 for each orthogonal axis from each of the coils 401, 402, 403 to be received at transducer receiving coils 501, 502, 503 of magnetic sensing device 206. At step 1204, the signals 301, 302, 303 of the detected magnetic field 230 from the magnetic emitter 202 are processed to determine a position of the magnetic sensing device 206 and, consequently subject 1020. Magnetic sensing device 206 processes the signals 301, 302, 303 of the detected magnetic field 230 received at each of transducer receiving coils 501, 502, 503 through processor unit 602 received through interface 608 by employing programming from program storage unit 606. Magnetic sensing device 206 may distinguish the values of the three transducer signals 501, 502, 503 to determine a position of magnetic sensing device 206 relative to magnetic emitter 202. Magnetic sensing device 206 may store the determined position data in memory unit 604 and communicate the position to transmitter 512 through interface 608. At step 1206, magnetic sensing device 206 communicates the determined position data through transmitter 512 to an image capturing device 210, thereby communicating the position of subject 1020 to image capturing device 210 based on the position of magnetic sensing device 206 attached to subject 1020.

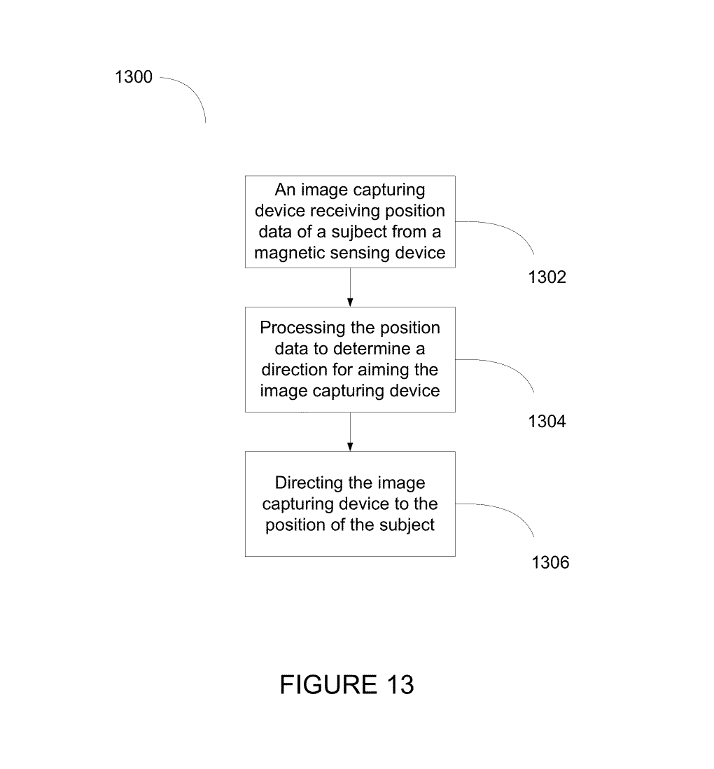

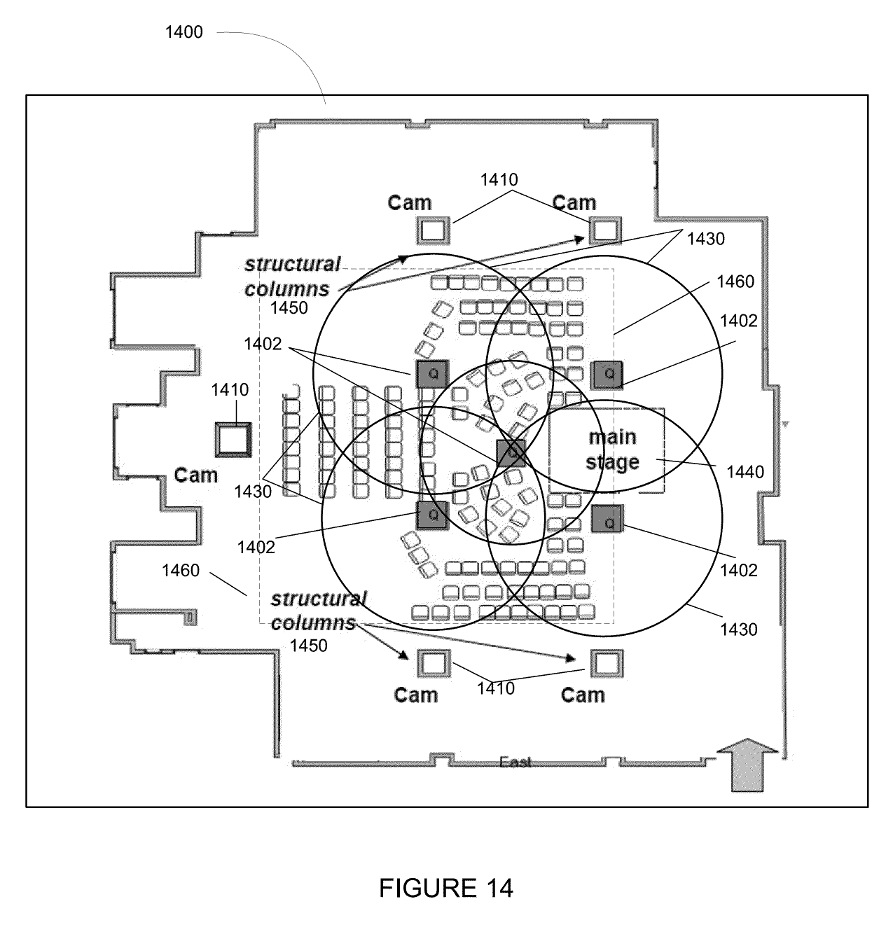

FIG. 13 is a flow diagram of steps of a method 1300 for directing the image capturing device to a subject position in an exemplary embodiment of the present invention. Again, referring to FIGS. 2-5, 7 and 10, the method 1300 begins at step 1302 where image capturing device 210 receives position data of a subject 1020 from magnetic sensing device 206 attached to subject 1020. Image capturing device 210 may receive the position data through receiver 702. At step 1304, control unit 704 receives the position information from receiver 702 through interface 808. Processor 802 in control unit 704 processes the position data employing programming stored in program storage unit 806 to determine a position for directing the image capturing device 210 and may store the position data in memory unit 804. At step 1306, control unit 704 communicates the position data through interface 808 to control unit 708, directing the image capturing device 210 to the position subject 1020. FIG. 14 is an illustration of an exemplary application of multiple elements in an exemplary embodiment of the present invention. In the example illustrated in FIG. 14, a presentation environment 1400 is shown with main stage 1440 and image capturing devices 1410 mounted to structural supports 1450. Magnetic emitters 1402 are positioned around the audience area (dashed line) 1460 whose magnetic fields 1430 encompass the majority of the audience area 1460 and all of main stage 1440. In the manner of the embodiment of FIG. 14, a subject or subjects with magnetic sensing devices (not shown) may easily move around main stage 1440 and the majority of audience area 1460 with continual tracking of image capturing devices 1410 using embodiments of the present invention.

The present invention may be implemented in many applications where it is desirable for a subject to be tracked automatically by an imaging device and may include live or virtual applications.

In some embodiments of the present invention, the presentation environment may be a lecture in academic, a group meeting, political debate, or other similar presentation environments.

In some other embodiments of the present invention, the presentation environment may be a video conferencing application.

In yet other embodiments of the present invention, the presentation environment may be theatrical, television, motion picture, virtual reality or other entertainment environments.

Furthermore, the present invention may flexibly allow multiple arrays of image capturing devices that may be applied to the systems and methods discussed herein.

In some embodiments of the present invention, the image capturing device may be a high definition video camera.

In some embodiments of the present invention, the image capturing device may be a camera capable of three dimensional image capture.

In some other embodiments of the present invention, the image capturing device may be a still image camera.

In yet other embodiments of the present invention, the image capturing device may a standard definition video camera.

In other embodiments of the present invention, the image capturing device may record images or transmit images for viewing or separate recording.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A system for an image capturing device to automatically track a subject comprising:
at least one magnetic emitter device emitting a magnetic field;
at least one magnetic sensing device enabled to receive the magnetic field from the at least one magnetic emitter device, the magnetic sensing device attached to at least one subject;
at least one image capturing device in communication with the at least one magnetic sensing device, the at least on magnetic sensing device enabled to communicate position data to the at least one image capturing device and the position data enables the at least one image capturing device to track a position of the at least one subject.

2. The system of claim 1, wherein the magnetic field comprises an emission signal defined by three mutually orthogonal axis of a coordinate system.

3. The system of claim 2, wherein the position data is based on the emission signal and defines a position of the at least one magnetic sensing device relative to the at least one magnetic emitter device.

4. The system of claim 3, wherein the image capturing device is enabled to capture an image of the at least one subject based on the position of the at least one magnetic sensing device.

5. The system of claim 1, wherein the at least one image capturing device further comprises a mechanism for pan, tilt and zoom capabilities.

6. The system of claim 1, wherein the at least one image capturing device is a video camera capable of high definition, standard definition or 3D image capture.

7. The system of claim 1, wherein the at least one image capturing device is a still image camera.

8. The system of claim 1, wherein the position data is communicated to the at least one image capturing device via an RF signal.

9. The system of claim 1, wherein the wherein the position data is communicated to the at least one image capturing device via an IEEE 802.11x signal.

10. A method for automatically acquiring a position of a subject comprising:
receiving at at least one magnetic sensing device attached to at least one subject a magnetic field from at least one magnetic emitter device;
processing a signal form the magnetic field to determine position data of the at least one magnetic sensing device;
communicating the position data of the at least one magnetic sensing device to at least one image capturing device; and
enabling the at least one image capturing device to track the at least one subject based on the position data of the at least one magnetic sensing device.

11. The method of claim 10, wherein the magnetic field comprises an emission signal defined by three mutually orthogonal axis of a coordinate system.

12. The method of claim 11, wherein the position data is based on the emission signal and defines a position of the at least one magnetic sensing device relative to the at least one magnetic emitter device.

13. The method of claim 12, wherein the at least one image capturing device is enabled to capture an image of the at least one subject based on the position data of the at least on magnetic sensing device.

14. The method of claim 10, wherein the at least one image capturing device is capable of high definition, standard definition or 3D image capture.

15. The method of claim 10, wherein the at least one image capturing device is a capable of still image capture.

16. The method of claim 10, wherein the position data is communicated to the at least one image capturing device via an RF signal.

17. The method of claim 10, wherein the wherein the position data is communicated to the at least one image capturing device via an IEEE 802.11x signal.

18. A method for automatically directing an image capturing device to a subject position comprising:
receiving at at least one image capturing device position data from at least one magnetic sensing device attached to at least one subject;
processing the position data to determine a position for directing the at least one image capturing device; and
directing the at least one image capturing device to the at least one subject based on the position of the at least one magnetic sensing device.

19. The method of claim 18, wherein the position data is based on an emission signal of the magnetic field defined by three mutually orthogonal axis of a coordinate system.

20. The method of claim 18, wherein the at least one image capturing device is enabled to capture an image of the at least one subject based on the position data of the at least on magnetic sensing device.
